(19) United States
(12) Patent Application Publication
(10) Pub. No.: US 2022/0242318 A1
(43) Pub. Date: Aug. 4, 2022

(54) 360-DEGREE VEHICLE VIDEO SURVEILLANCE SYSTEM

(71) Applicant: Floyd Henderson, JR., Lawrenceville, GA (US)

(72) Inventor: Floyd Henderson, JR., Lawrenceville, GA (US)

(21) Appl. No.: 17/400,105

(22) Filed: Aug. 11, 2021

Related U.S. Application Data
(60) Provisional application No. 63/064,319, filed on Aug. 11, 2020.

(51) Int. Cl. B60R 1/27; B60R 11/04

(52) U.S. Cl. CPC B60R 1/27; B60R 2011/005; B60R 11/04

(57) ABSTRACT

A 360-degree vehicle video surveillance system is described. In some implementations, the system can include a control unit having a processor coupled to a nontransitory computer readable medium having stored thereon software instructions that, when executed by the processor, cause the processor to perform operations to control video surveillance operations, a data storage module coupled to the processor and configured to store video surveillance data, a position sensing module coupled to the processor and configured to electronically determine position of the system, and a data communications module coupled to the processor and configured to transmit video surveillance data to an external system. The system also includes one or more imaging modules coupled to the control unit, each imaging module including at least one video imaging sensor, an additional sensor, and a base configured to releasably attaching the imaging module to a vehicle.

### RELATED APPLICATIONS

This application claims the benefit of U.S. Provisional Application No. 63/064,319, entitled “360-DEGREE VEHICLE VIDEO SURVEILLANCE SYSTEM,” and filed on Aug. 11, 2020, which is incorporated herein by reference.

### TECHNICAL FIELD

Embodiments relate generally to video surveillance systems, and more particularly, to a 360-degree vehicle video surveillance system.

### BACKGROUND

Some existing video recording systems may only capture an event after a user activates recording. Such systems may miss a portion of the event and may not capture a complete timeline of an event on video from multiple angles. Also, some video surveillance systems may be difficult to install or use on a vehicle.

Some implementations were conceived in light of the above-mentioned needs, problems and/or limitations, among other things.

### SUMMARY

Some implementations can include a control unit having a processor coupled to a nontransitory computer readable medium having stored thereon software instructions that, when executed by the processor, cause the processor to perform operations to control video surveillance operations, a data storage module coupled to the processor and configured to store video surveillance data, a position sensing module coupled to the processor and configured to electronically determine position of the system, and a data communications module coupled to the processor and configured to transmit video surveillance data to an external system. The system also includes one or more imaging modules coupled to the control unit, each imaging module including at least one video imaging sensor, an additional sensor, and a base configured to releasably attaching the imaging module to a vehicle.

### BRIEF DESCRIPTION OF THE DRAWINGS

FIG. 1 is a diagram of an example 360-degree vehicle video surveillance system in accordance with some implementations.

FIG. 2 is a diagram of a front view of an example imaging and sensor module of a 360-degree vehicle video surveillance system in accordance with some implementations.

FIG. 3 is a diagram a back view of an example imaging and sensor module of a 360-degree vehicle video surveillance system in accordance with some implementations.

FIG. 4 is a diagram of a bottom view of an example imaging and sensor module of a 360-degree vehicle video surveillance system in accordance with some implementations.

FIG. 5 is a diagram of an example imaging and sensor module of a 360-degree vehicle video surveillance system showing an image sensor housing and a base in accordance with some implementations.

FIG. 6 is a diagram of a base of an example imaging and sensor module of a 360-degree vehicle video surveillance system in accordance with some implementations.

FIG. 7 is a diagram of an example surveillance zone pattern of a 360-degree vehicle video surveillance system in accordance with some implementations.

FIG. 8 is a diagram of an example computing device configured for electronic employment document control in accordance with at least one implementation.

FIG. 9 is a diagram of an example imaging and sensor module with four video cameras in accordance with some implementations.

FIG. 10 is a diagram of an example dash mountable imaging and sensor module with a mobile phone holder in accordance with some implementations.

FIG. 11 is a top perspective view of an example imaging module in accordance with some implementations.

FIG. 12 is a bottom perspective view of an example imaging module and base in accordance with some implementations.

FIG. 13 is a side profile view of an example imaging module in accordance with some implementations.

FIG. 14 is a front profile view of an example imaging module in accordance with some implementations.

FIG. 15 is a side profile view of an example imaging module in accordance with some implementations.

FIG. 16 is a bottom perspective view of an example imaging module without base in accordance with some implementations.

FIG. 17 is a bottom perspective view of an example imaging module without base in accordance with some implementations.

FIG. 18 is a perspective view of an example imaging module base in accordance with some implementations.

### DETAILED DESCRIPTION

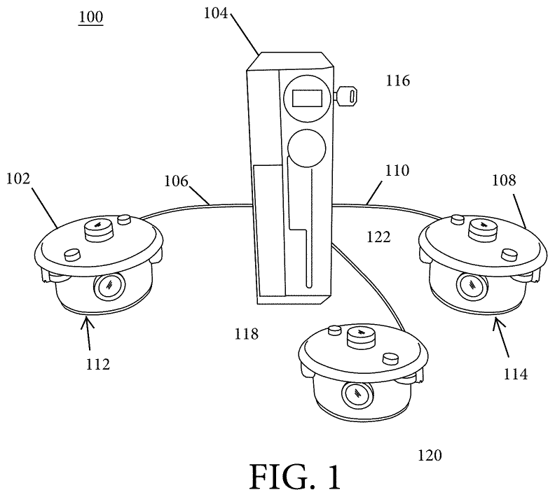

FIG. 1 is a diagram of an example 360-degree vehicle video surveillance system 100 in accordance with some implementations. The system 100 includes a first imaging and sensor module 102, a secure control unit 104, a second imaging and sensor module 108, and a third imaging and sensor module 118. The first imaging and sensor module 102 includes a base 112 and is coupled to the secure control unit 104 via a cable 106. The second imaging and sensor module 108 includes a base 114 and is coupled to the secure control unit 104 via a cable 110. The second imaging and sensor module 118 includes a base 120 and is coupled to the secure control unit 104 via a cable 122.

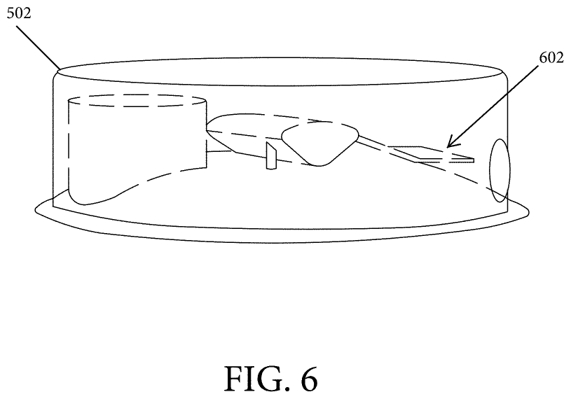

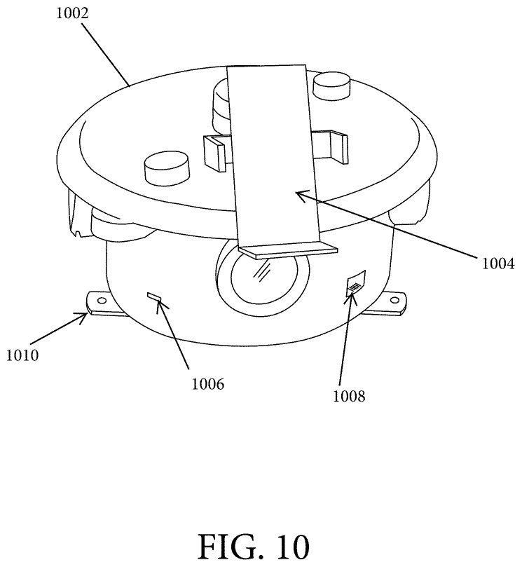

In some implementations, the cables (e.g., 106, 110, and 122) can include an Ethernet cable such as CAT-5 or CAT-6 with RJ45 connectors that provides power to the imaging and sensor module and receives video data. In some implementations, the imaging and sensor modules can be coupled to the secure control unit 104 via a wireless interface (e.g., Wi-Fi, Bluetooth, etc.). In some implementations, the bases (112, 114, and 120) of each imaging and sensor module can include a mechanism to releasably attach to a vehicle such as a magnet or a suction cup (as shown in FIG. 6). In some implementations, the bases (112, 114, and 120) of each imaging and sensor module can be permanently mounted to the exterior of a vehicle or mounted to a dash of a vehicle (e.g., as shown in FIG. 10).

In operation, the secure control unit 104 activates the imaging and sensor modules (102, 108, and/or 118) and receives video signals and/or other signals (e.g., proximity signals) from the imaging and sensor modules. The video signals from the imaging and sensor modules can be recorded in the secure control unit 104 so that the secure control unit functions as vehicle data recorder capturing and recording video data and other data such as GPS location, etc. The video signals from the imaging and sensor modules can be combined by the secure control unit 104 and sent to a mobile device for display in a mobile application, sent to a display in the vehicle or other location for a live (or near real-time) view of the images from the video cameras.

The secure control unit 104 can also include a communications module to communicate with an external system. For example, the secure control unit 104 can transmit the video signals from the imaging and sensor modules to an external system such as a dispatch, command, or monitoring system. The secure control unit 104 can also include a lock 116 to secure the contents (e.g., data storage devices) of the secure control unit 104. In some implementations, the secure control unit 104 can include a position location device such as a global positioning system (GPS).

In operation, the secure control unit 104 can be activated or deactivated by remote control (e.g., similar to a vehicle remote control or keyless entry device). In some implementations, the secure control unit can be wired into a vehicle power system to receive power when the vehicle is on or off. The recording function can be performed in a loop that captures a duration of time based on the size of the storage device in the secure control unit 104. Proximity sensors on the imaging and sensor modules can be used to detect proximity or movement near a vehicle and alert the driver of the vehicle (e.g., via audible or visible alert, or alert on a mobile application) or other operator or system (e.g., a dispatcher system).

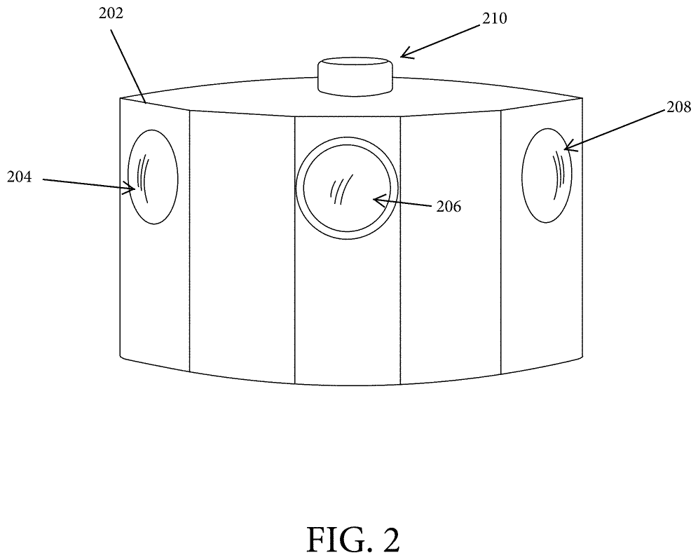

FIG. 2 is a diagram of a front view of an imaging and sensor module 202 of a 360-degree vehicle video surveillance system in accordance with some implementations. The imaging and sensor module 202 includes a first sensor 204, a camera (video imaging sensor) 206, a second sensor 208, and a light 210. The sensors (204 and 208) can each be a proximity sensor, video imaging sensor or other sensor. The imaging and sensor modules shown herein (e.g., 102, 108, and/or 118) can include similar features as 202.

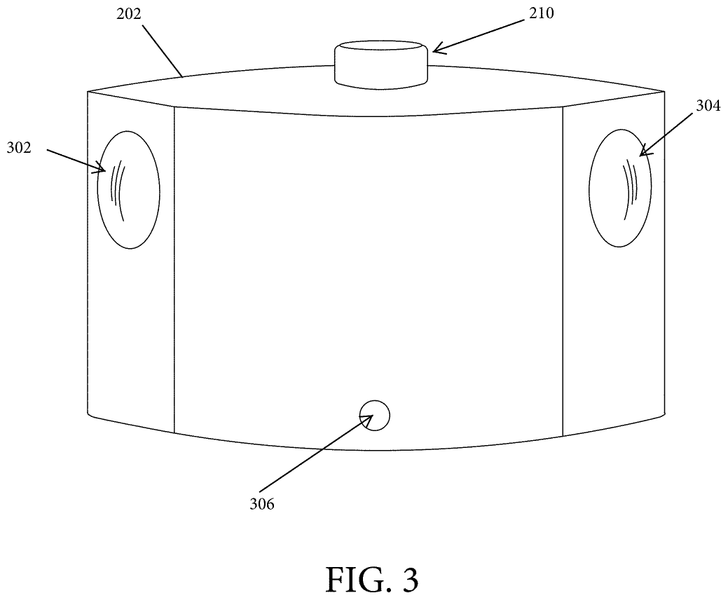

FIG. 3 is a diagram a back view of the imaging and sensor module 202 showing a third sensor 302, a fourth sensor 304, and a cable port 306.

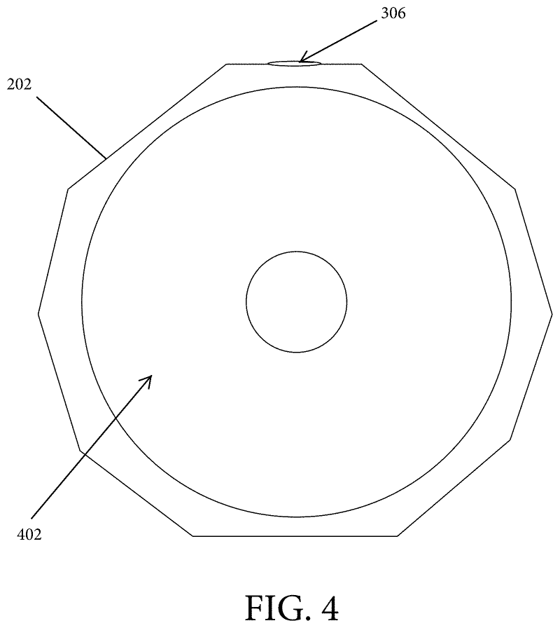

FIG. 4 is a diagram of a bottom view of the imaging and sensor module 202 showing the camera 206 and an attachment mechanism 402. The attachment mechanism 402 can be a magnet or a suction cup for releasably attaching the imaging and sensor module 202 to a vehicle.

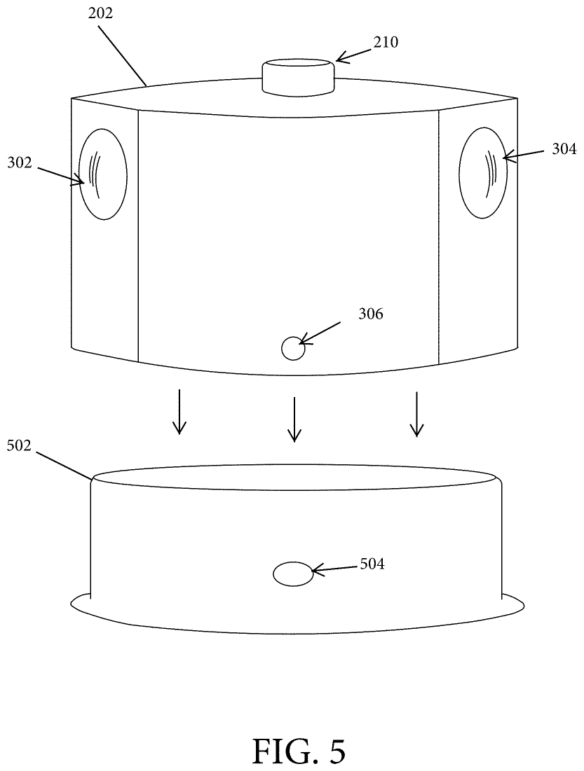

FIG. 5 is a diagram of the imaging and sensor module 202 of a 360-degree vehicle video surveillance system showing how an image sensor housing 202 fits onto a base 502. The base 502 includes a base cable port 504.

FIG. 6 is a diagram of the base 502 of an imaging and sensor module 202 showing a suction cup 602.

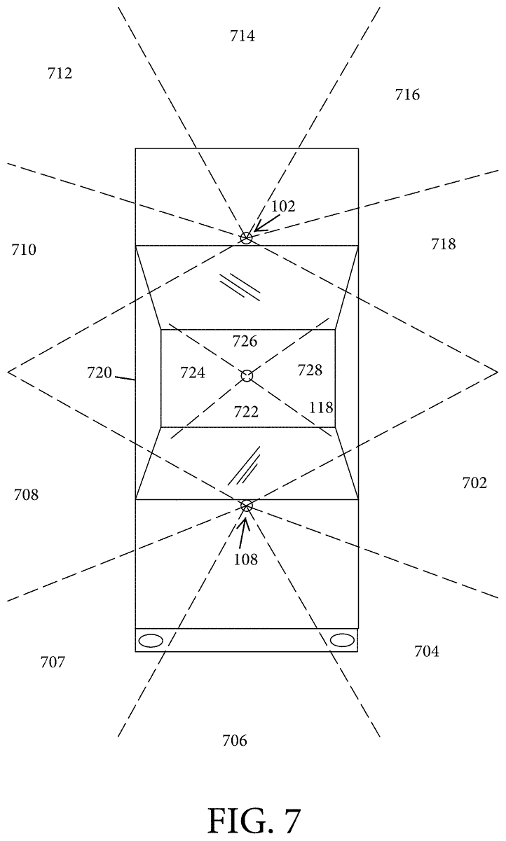

FIG. 7 is a diagram of a surveillance zone pattern of a 360-degree vehicle video surveillance system in accordance with some implementations. The imaging and sensor modules 102 and 108 mounted on a vehicle provide video coverage over a plurality of zones (702-718) to provide a 360-degree view (or near 360-degree view) around the vehicle. An optional third imaging and sensor module 118 can be placed on top of the vehicle to provide four-way video camera zones (e.g., 722, 724, 726, and 728). The surveillance zones can also be enhanced by an optional imaging and sensor module placed on a dash (e.g., as shown in FIG. 10).

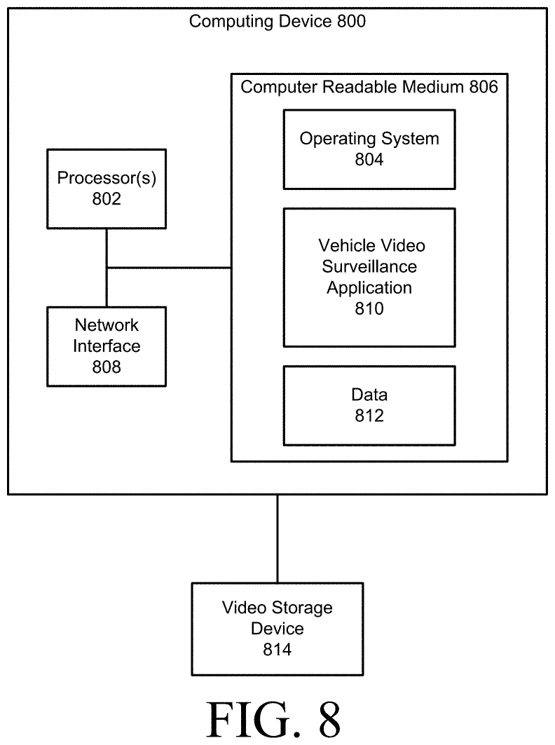

FIG. 8 is a diagram of an example computing device 800 in accordance with at least one implementation. The computing device 800 includes one or more processors 802, nontransitory computer readable medium 806 and network interface 808. The computer readable medium 806 can include an operating system 804, a 360-degree vehicle video surveillance application 810, a data section 812 (e.g., for short term storage of video data, etc.), and a video data storage device 1414 (e.g., for longer term storage of surveillance video data or other data associated with video surveillance).

In operation, the processor 802 may execute the application 810 stored in the computer readable medium 806. The application 810 can include software instructions that, when executed by the processor, cause the processor to perform operations to perform and control 360-degree vehicle video surveillance in accordance with the present disclosure.

The application program 810 can operate in conjunction with the data section 812 and the operating system 804.

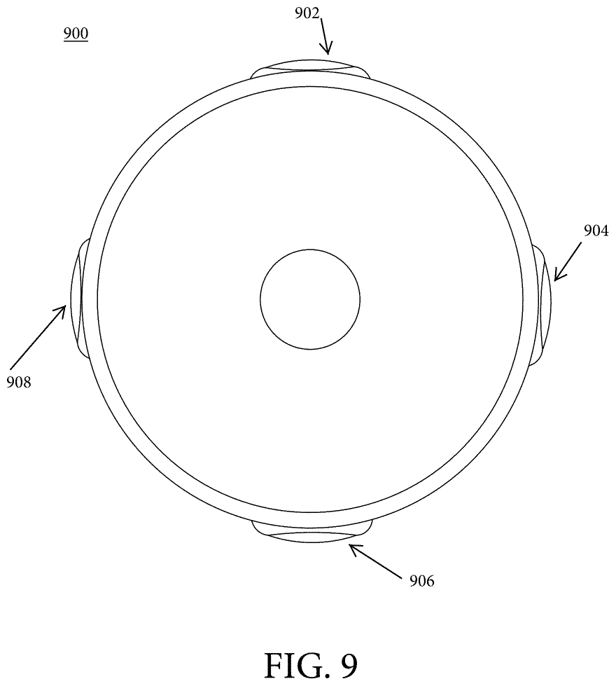

FIG. 9 is a diagram of an example imaging and sensor module 900 with four video cameras (902-908) in accordance with some implementations. The imaging and sensor module 900 can be used on top of a vehicle (e.g., as module 118 in FIGS. 1 and 7).

FIG. 10 is a diagram of an example dash mountable imaging and sensor module 1002 having a mobile phone holder 1004, a phone charging port (e.g., USB, Apple lightening, USB-C, etc.), and an RJ45 connector 1008.

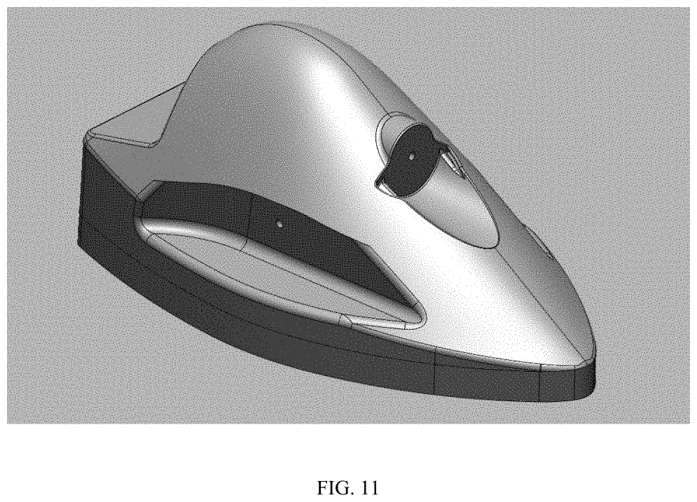

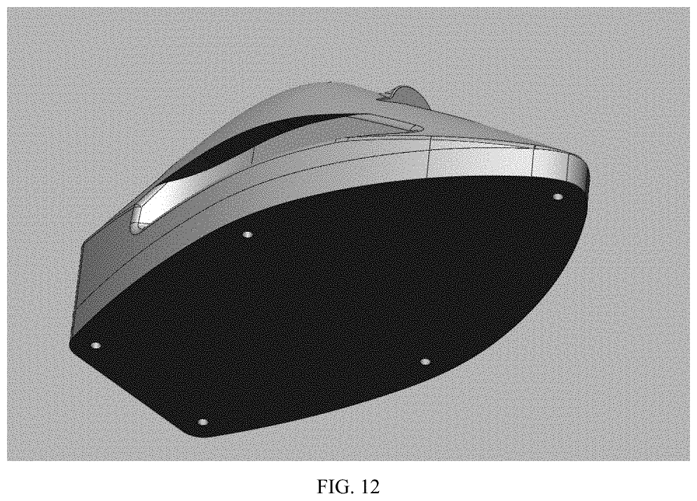

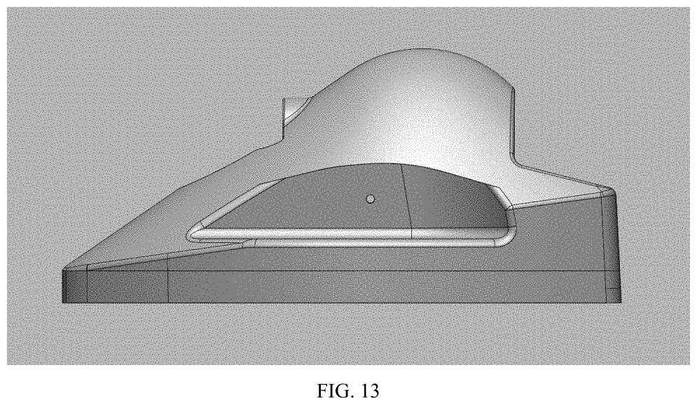

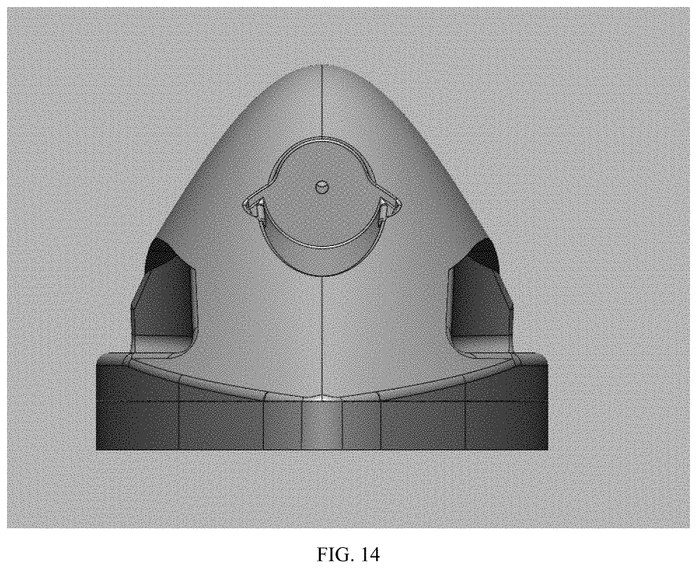

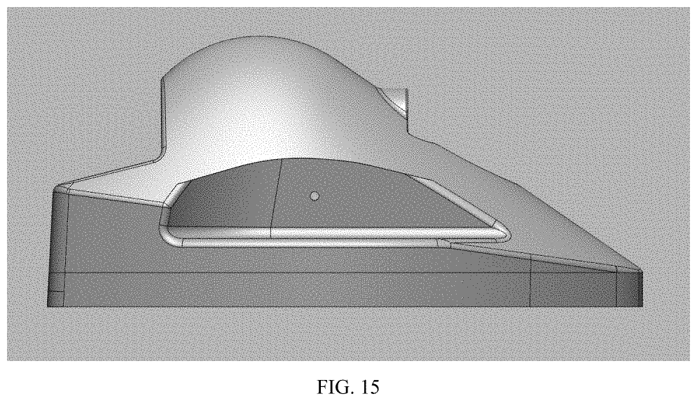

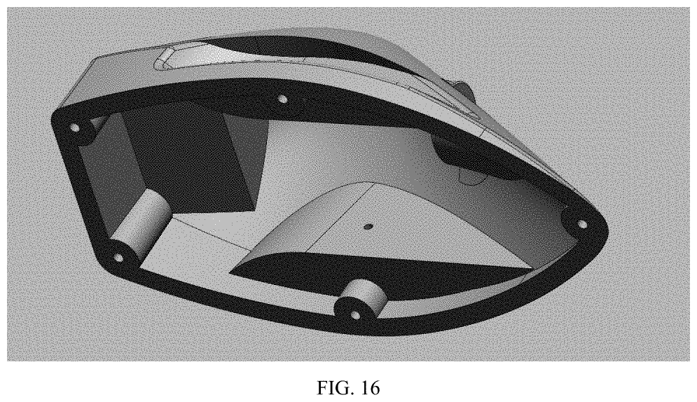

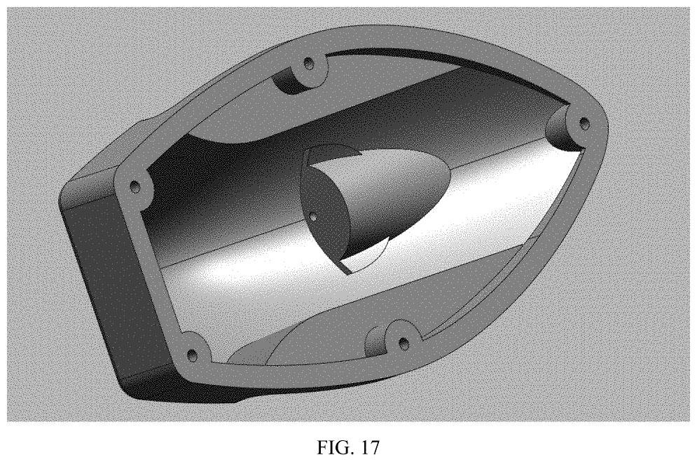

FIGS. 11-17 shows various views of an example image module with and without a base. The imaging module includes a front camera location, a first side camera location, a second side camera location, and a rear camera location. The imaging module also includes a base. The imaging module includes a recess to house wiring, connectors, etc.

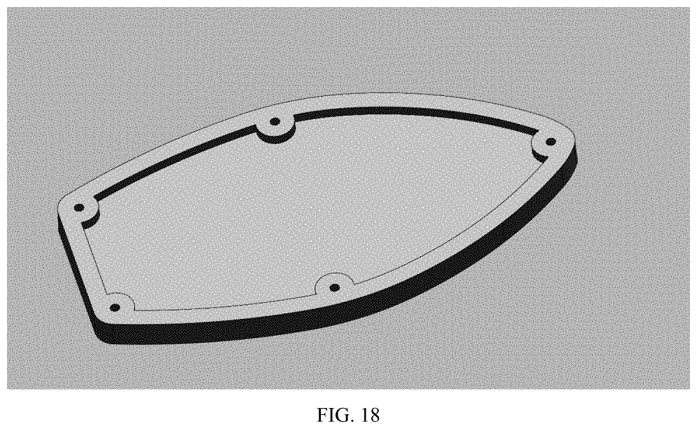

FIG. 18 shows a base configured to attach to the imaging module and to a vehicle.

It will be appreciated that the modules, processes, systems, and sections described above can be implemented in hardware, hardware programmed by software, software instructions stored on a nontransitory computer readable medium or a combination of the above. A system as described above, for example, can include a processor configured to execute a sequence of programmed instructions stored on a nontransitory computer readable medium. For example, the processor can include, but not be limited to, a personal computer or workstation or other such computing system that includes a processor, microprocessor, microcontroller device, or is comprised of control logic including integrated circuits such as, for example, an Application Specific Integrated Circuit (ASIC). The instructions can be compiled from source code instructions provided in accordance with a programming language such as Java, C, C++, C#.net, assembly or the like. The instructions can also comprise code and data objects provided in accordance with, for example, the Visual Basic™ language, or another structured or object-oriented programming language. The sequence of programmed instructions, or programmable logic device configuration software, and data associated therewith can be stored in a nontransitory computer-readable medium such as a computer memory or storage device which may be any suitable memory apparatus, such as, but not limited to ROM, PROM, EEPROM, RAM, flash memory, disk drive and the like.

Furthermore, the modules, processes systems, and sections can be implemented as a single processor or as a distributed processor. Further, it should be appreciated that the steps mentioned above may be performed on a single or distributed processor (single and/or multi-core, or cloud computing system). Also, the processes, system components, modules, and sub-modules described in the various figures of and for embodiments above may be distributed across multiple computers or systems or may be co-located in a single processor or system. Example structural embodiment alternatives suitable for implementing the modules, sections, systems, means, or processes described herein are provided below.

The modules, processors or systems described above can be implemented as a programmed general purpose computer, an electronic device programmed with microcode, a hard-wired analog logic circuit, software stored on a computer-readable medium or signal, an optical computing device, a networked system of electronic and/or optical devices, a special purpose computing device, an integrated circuit device, a semiconductor chip, and/or a software module or object stored on a computer-readable medium or signal, for example.

Embodiments of the method and system (or their sub-components or modules), may be implemented on a general-purpose computer, a special-purpose computer, a programmed microprocessor or microcontroller and peripheral integrated circuit element, an ASIC or other integrated circuit, a digital signal processor, a hardwired electronic or logic circuit such as a discrete element circuit, a programmed logic circuit such as a PLD, PLA, FPGA, PAL, or the like. In general, any processor capable of implementing the functions or steps described herein can be used to implement embodiments of the method, system, or a computer program product (software program stored on a nontransitory computer readable medium).

Furthermore, embodiments of the disclosed method, system, and computer program product (or software instructions stored on a nontransitory computer readable medium) may be readily implemented, fully or partially, in software using, for example, object or object-oriented software development environments that provide portable source code that can be used on a variety of computer platforms. Alternatively, embodiments of the disclosed method, system, and computer program product can be implemented partially or fully in hardware using, for example, standard logic circuits or a VLSI design. Other hardware or software can be used to implement embodiments depending on the speed and/or efficiency requirements of the systems, the particular function, and/or particular software or hardware system, microprocessor, or microcomputer being utilized. Embodiments of the method, system, and computer program product can be implemented in hardware and/or software using any known or later developed systems or structures, devices and/or software by those of ordinary skill in the applicable art from the function description provided herein and with a general basic knowledge of the software engineering and computer networking arts.

Moreover, embodiments of the disclosed method, system, and computer readable media (or computer program product) can be implemented in software executed on a programmed general purpose computer, a special purpose computer, a microprocessor, a network server or switch, or the like.

It is, therefore, apparent that there is provided, in accordance with the various embodiments disclosed herein, a 360-degree vehicle video surveillance system and methods, systems and computer readable media to control and operate a 360-degree vehicle video surveillance system.

While the disclosed subject matter has been described in conjunction with a number of embodiments, it is evident that many alternatives, modifications, and variations would be, or are, apparent to those of ordinary skill in the applicable arts. Accordingly, Applicant intends to embrace all such alternatives, modifications, equivalents, and variations that are within the spirit and scope of the disclosed subject matter.

What is claimed is:

1. A system comprising:
a control unit including:
a processor coupled to a nontransitory computer readable medium having stored thereon software instructions that, when executed by the processor, cause the processor to perform operations to control video surveillance operations;
a data storage module coupled to the processor and configured to store video surveillance data;
a position sensing module coupled to the processor and configured to electronically determine position of the system;
a data communications module coupled to the processor and configured to transmit video surveillance data to an external system; and
one or more imaging modules coupled to the control unit, each imaging module including at least one video imaging sensor, an additional sensor, and a base configured to releasably attach the imaging module to a vehicle.

2. The system of claim 1, wherein the additional sensor includes a proximity sensor.

3. The system of claim 1, wherein each imaging module includes four imaging sensors disposed on a front imaging sensor location, a first side imaging sensor location, a second side imaging sensor location, and a rear imaging sensor location, respectively.

4. The system of claim 1, wherein each imaging module includes a connector, wherein the control unit includes a connector corresponding to each imaging module, and wherein the connectors are CAT-5 network cable connectors.
